(19) United States
(12) Patent Application Publication
(10) Pub. No.: US 2019/0241008 A1
(43) Pub. Date: Aug. 8, 2019

(54) HOT FOIL LOGO

(71) Applicant: HEWLETT-PACKARD DEVELOPMENT COMPANY, L.P., HOUSTON, TX (US)

(72) Inventors: KUAN-TING WU, TAIPEI CITY (TW); HANG-YAN YUEN, FORT COLLINS, CO (US)

(21) Appl. No.: 16/325,473

(22) PCT Filed: Oct. 14, 2016
(86) PCT No.: PCT/US2016/056939

§ 371 Date: Feb. 14, 2019

(51) Int. Cl. B44C 1/14; B44C 1/17

(52) U.S. Cl. CPC B44C 1/14; B44C 1/1716

(57) ABSTRACT

The present subject matter describes imprinting a logo on a substrate. In an example implementation, a first layer is coated on the substrate to level surface irregularities on the substrate. The first layer is a thermally cured layer. A hot foil imprint of the logo is formed on the first layer. A second layer is coated on the hot foil imprint, where the second layer is a thermally cured transparent layer. A third layer is coated on the second layer, where the third layer is an ultra-violet (UV) cured transparent layer.

### BACKGROUND

Logos of a manufacturers name, symbol, or a graphic mark imprinted on a device, help users to readily distinguish between a product of a particular manufacturer from products of others. Logos may have a metallic luster that gives an aesthetic appeal to the device, attracts user attention, and complements the appearance and design features of the device.

### BRIEF DESCRIPTION OF DRAWINGS

The following detailed description references the drawings, wherein:

FIG. 1 illustrates a sectional view of an enclosure of a device, according to an example implementation of the present subject matter;

FIG. 2 illustrates a device having an enclosure, according to an example implementation of the present subject matter; and

FIG. 3 illustrates a method of imprinting a logo on a substrate, according to an example implementation of the present subject matter.

### DETAILED DESCRIPTION

Logos, such as hot foil logos are generally formed from metallic foils. A metallic foil may be stamped on a substrate by applying specific pressure and heat for forming the hot foil logo on the substrate. The substrate may be an enclosure of a device, such as an electronic device. Electronic devices, such as laptops, tablets, and smart phones, may have hot foil logos, illustrating graphic marks, emblems, or symbols, imprinted on their plastic or fiber body.

A hot foil logo may be imprinted on a substrate made from metal or plastic or carbon fiber or a plastic-carbon fiber composite. During imprinting the hot foil logo, after the logo is stamped on the substrate, a top layer is generally coated on the logo. After coating the top layer, the top layer is exposed to UV radiations for curing. The top layer serves as a protective layer which prevents rusting and corrosion of the hot foil logo.

In the above description, the top layer overlaying the hot foil logo is weakly bound to the hot foil logo surface beneath it. Thus, during imprinting, when the top layer is cured by UV radiations, the top layer often shrinks and may develop surface cracks resulting in logo rupture. The surface cracks on the top layer may also result in the hot foil logo getting damaged/defaced during the process of imprinting or later during use. The damaged logo may lose its aesthetic appeal and become unusable.

Also, because of the weak bonding between the hot foil logo surface and the top layer, the top layer tends to peel off due to wear and tear during use. With the top layer peeled off, the metallic foil of the hot foil logo gets exposed to the atmosphere which may result in the logo getting rusted, corroded, displaced or detached from the substrate.

The present subject matter describes enclosures of devices imprinted with hot foil logos, devices having such enclosures, and methods of imprinting such hot foil logos. The hot foil logos of the present subject matter do not rupture during imprinting and are durable.

In an example implementation of the present subject matter, a thermally cured layer is coated on a surface of a substrate, where the thermally cured layer levels irregularities on the surface. A hot foil logo is imprinted on the thermally cured layer. The hot foil logo is coated with a thermally cured transparent layer. The thermally cued transparent layer is coated with an ultra-violet (UV) cured transparent layer.

The thermally cured transparent layer disposed between the hot foil logo and the UV cured transparent layer binds the hot foil logo with the UV cured transparent layer by forming chemical bond between the hot foil logo and the UV cured transparent layer. The binding between the hot foil logo and the UV cured transparent layer prevents shrinking of the UV cured transparent layer during imprinting and thereby logo rupture may be eliminated.

Further, the thermally cured transparent layer binds to the UV cured transparent layer and may prevent the UV cured transparent layer from peeling off. As a result, the UV cured transparent layer retained which may prevent rusting and corrosion of the metallic foil of the hot foil logo and thereby may increase durability of the hot foil logo. The UV cured transparent layer bound by the thermally cured transparent layer may also prevent the hot foil logo from getting displaced or detached from the surface of the substrate.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

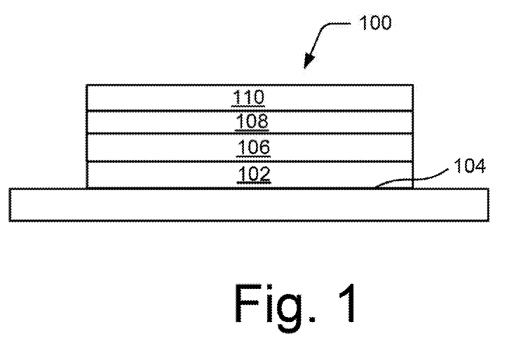

FIG. 1 illustrates a sectional view of an enclosure 100 of a device, according to an example implementation of the present subject matter. In an example implementation, the enclosure 100 may be a casing or housing for electrical and electronic components of an electronic device. In an example implementation, the enclosure 100 may be a back cover or a front panel of a laptop, a tablet, or a smart phone.

As shown, the enclosure 100 has a thermally cured layer 102 coated on a surface 104 of the enclosure 100 that facilitates in levelling irregularities on the surface 104. The surface 104 denotes a surface of the enclosure 100 on which a hot foil logo is to be formed. In an example implementation, a layer made of one of polyurethane, acrylic-polyurethane, and silicone rubber is spray coated on the surface 104 and then the layer is heated at a temperature in a range of about 50° C. to about 70° C. for a time duration in a range of about 10 minutes to about 15 minutes to form the thermally cured layer 102. In an example implementation, the thermally cured layer 102 may have a thickness in a range of 8 μm to 15 μm.

The enclosure 100 has a hot foil logo 106 formed on the thermally cured layer 102. The hot foil logo 106 is made of a metallic foil through hot foil stamping of the logo. The hot foil stamping is performed at a temperature in a range of about 180° C. to about 220° C. and a pressure in a range of about 3 kg/m²to about 5 kg/m².

In an example implementation, the metallic foil is made of one of aluminum, copper, gold, chromium, and silver. After the hot foil stamping, the hot foil logo 106 gets embossed on the thermally cured layer 102. In an example implementation, the hot foil logo 106 may have a thickness in a range of 3 μm to 25 μm.

Further, the enclosure 100 has a thermally cured transparent layer 108 coated on the hot foil logo 106. In an example implementation, a layer made of one of polyurethane, silicone rubber, and fluoropolymer is spray coated on the hot foil logo 106 and then the layer is heated at a temperature in a range of about 55° C. to about 60° C. for a time duration in a range about 10 minutes to about 15 minutes to form the thermally cured transparent layer 108. In an example implementation, the thermally cured transparent layer 108 may have a thickness in a range of 1 μm to 5 μm.

Further, the enclosure 100 has an ultra-violet (UV) cured transparent layer 110 coated on the thermally cured transparent layer 108. In an example implementation, a layer made of one of polyurethane, polycarbonate, urethane acrylates, polyacrylate, polystyrene, polyetheretherketone, polyesters, fluoropolymers, and a combination thereof is spray coated on the thermally cured transparent layer 108 and then the layer is heated at a temperature in a range of about 50° C. to about 60° C. for a time duration in a range of about 10 minutes to about 15 minutes. After heating, the layer is exposed to UV radiations with radiant exposure in a range of about 700 milliJoule/cm² to about 1200 milliJoule/cm² for a time duration in a range of about 15 seconds to about 60 seconds to form the ultra-violet (UV) cured transparent layer 110. The UV cured transparent layer 110 serves as a protective coating on the hot foil logo 106 and prevents the hot foil logo 106 from getting damaged. In an example implementation, the UV cured transparent layer 110 may have a thickness in a range of 10 μm to 25 μm.

The thermally cured transparent layer 108 disposed between the hot foil logo 106 and the UV cured transparent layer 110 binds the UV cured transparent layer 110 with the hot foil logo 106. The thermally cured transparent layer 108 may form a chemical bond between the UV cured transparent layer 110 and the hot foil logo 106 and thereby prevent the UV cured transparent layer 110 from peeling off. Presence of the thermally cured transparent layer 108 which facilitates in binding the UV cured transparent layer 110 to the hot foil logo 106 also prevents shrinkage of the UV cured transparent layer 110 during UV curing and helps in preventing logo rupture.

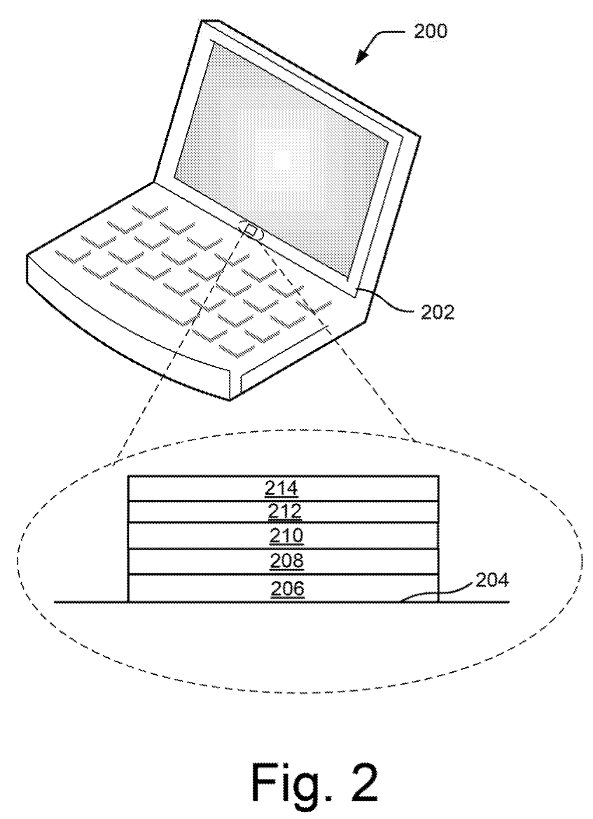

FIG. 2 illustrates a device 200 having an enclosure 202, according to an example implementation of the present subject matter. In an example implementation the device 200 may be an electronic device as shown in FIG. 2. The enclosure 202 has a surface 204, a primer layer 206 on the surface 204, a thermally cured layer 208 on the primer layer 206, a hot foil logo 210 on the thermally cured layer 208, a thermally cured transparent layer 212 on the hot foil logo 210, and a UV cured transparent layer 214 on the thermally cured transparent layer 212.

In an example implementation, the primer layer 206 may be deposited by spray coating on the surface 204. After depositing the primer layer 206, the primer layer 206 is heated at a temperature in a range of about 50° C. to about 60° C. for a time duration in a range of about 10 minutes to about 15 minutes. In an example implementation, the primer layer 206 may have a thickness in a range of 3 μm to 10 μm. The primer layer 206 may be made of one of acrylic-epoxy hybrids, acrylics, polycarbonate polyurethane and acrylic-polyurethane.

The thermally cured layer 208, the hot foil logo 210, the thermally cured transparent layer 212, and the UV cured transparent layer 214 may have material properties and thicknesses similar to the layers 102, 106, 108, and 110, respectively, as mentioned earlier. The thermally cured layer 208, the hot foil logo 210, the thermally cured transparent layer 212, and the UV cured transparent layer 214 may be formed in a similar manner as the layers 102, 106, 108, and 110, respectively.

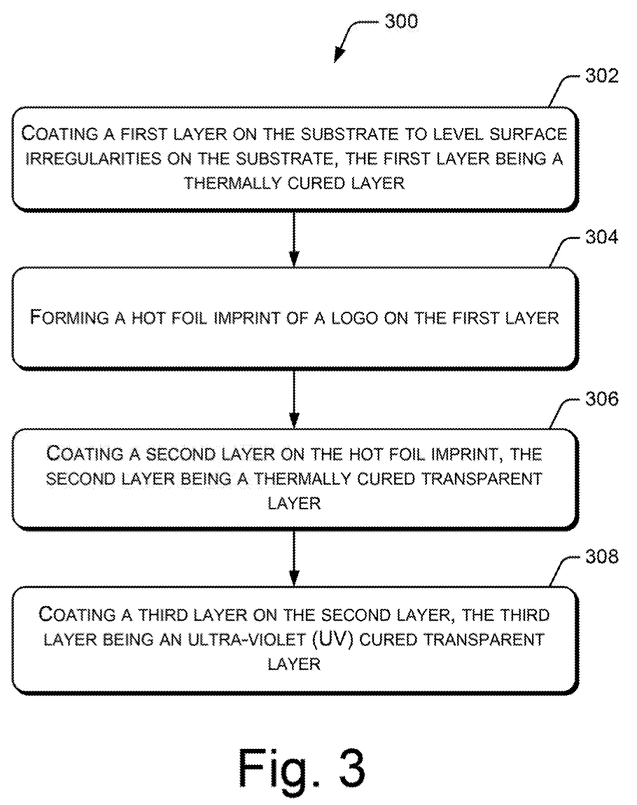

FIG. 3 illustrates a method 300 of imprinting a logo on a substrate, according to an example implementation of the present subject matter. Examples of the substrate include metal, plastic, carbon fiber, or composite material formed from metal, plastic, and carbon fiber. The substrate may be a top cover of a laptop, a back cover of a smart phone, and the like. In an example implementation, the substrate may be an enclosure 100 as illustrated in FIG. 1 or an enclosure 202 as illustrated in FIG. 2.

At block 302 of the method 300, a first layer is coated on the substrate, where the first layer is a thermally cured layer, such as the thermally cured layer 102 in FIG. 1. In an example implementation, the first layer is deposited on the substrate through spray coating and then the first layer is heated at a temperature in a range of 50° C. to 70° C. for a time duration in a range of 10 minutes to 15 minutes. The first layer, coated on the substrate, levels surface irregularities on the substrate. The first layer may have a thickness in a range of 8 μm to 15 μm. In an example implementation the first layer is made of one of polyurethane, acrylic-polyurethane, and silicone rubber.

In an example implementation, prior to coating the first layer on the substrate, a primer layer, such as the primer layer 206 of FIG. 2 may be coated on the substrate and then the first layer may be coated on the primer layer 206. The primer layer coated on the substrate facilitates adhesion of the first layer with the substrate to enhance durability of the substrate. In an example implementation, the primer layer may be deposited on the substrate through spray coating and after the spray coating, the primer layer may be heated at a temperature in a range of about 50° C. to about 60° C. for a time duration in a range of about 10 minutes to about 15 minutes. In an example implementation, the primer layer has material properties and thickness identical to the primer layer 206 illustrated in FIG. 2.

At block 304, a hot foil imprint of the logo is formed on the first layer. In an example implementation, the hot foil imprint is formed by hot foil stamping the logo using a metallic foil. The metallic foil may be made of one of aluminum, copper, gold, chromium, and silver. The hot foil stamping is done at a temperature in a range of about 180° C. to about 220° C. and at a pressure in a range of about 3 kg/m² to about 5 kg/m². The hot foil imprint of the logo may have a thickness in a range of about 3 μm to about 25 μm.

At block 306, a second layer is coated on the hot foil imprint of the logo, where the second layer is a thermally cured transparent layer, such as the thermally cured transparent layer 108 illustrated in FIG. 1. In an example implementation, the second layer is deposited on the hot foil imprint through spray coating and then the second layer is heated at a temperature in a range of 55° C. to 60° C. for a time duration in a range of 10 minutes to 15 minutes. The second layer may have a thickness in a range of 1 μm to 5 μm. In an example implementation, the second layer is made of one of one of polyurethane, silicone rubber, and fluoropolymer.

At block 308, a third layer is coated on the second layer, where the third layer is a ultra-violet (UV) cured transparent layer, such as the UV cured transparent layer 110 illustrated in FIG. 1. In an example implementation, the third layer is deposited on the second layer through spray coating; then the third layer is heated at a temperature in a range of 50° C. to 60° C. for a time duration in a range of 10 minutes to 15 minutes; and after heating, the third layer is exposed to ultra-violet radiations with radiant exposure in a range of about 700 milliJoule/cm² to about 1,200 milliJoule/cm² for a time duration in a range of about 15 seconds to about 60 seconds. The third layer may have a thickness in a range of 10 μm to 25 μm. In an example implementation the third layer is made of one of polyurethane, polycarbonate, urethane acrylates, polyacrylate, polystyrene, polyetheretherketone, polyesters, fluoropolymers, and a combination thereof.

Although implementations for enclosures of devices imprinted with hot foil logos, devices having such enclosures, and methods of imprinting such hot foil logos have been described in language specific to methods and/or structural features, it is to be understood that the present subject matter is not limited to the specific methods or features described. Rather, the methods and specific features are disclosed and explained as example implementations for enclosures of devices imprinted with hot foil logos, devices having such enclosures, and methods of imprinting such hot foil logos.

I/We claim:

1. A method of imprinting a logo on a substrate, comprising:
coating a first layer on the substrate to level surface irregularities on the substrate, the first layer being a thermally cured layer;
forming a hot foil imprint of the logo on the first layer;
coating a second layer on the hot foil imprint, the second layer being a thermally cured transparent layer; and
coating a third layer on the second layer, the third layer being an ultra-violet (UV) cured transparent layer.

2. The method as claimed in claim 1, wherein coating the first layer comprises:
depositing the first layer on the substrate through spray coating; and
heating the first layer at a temperature in a range of about 50° C. to about 70° C. for a time duration in a range of about 10 minutes to about 15 minutes.

3. The method as claimed in claim 1, wherein forming the hot foil imprint comprises hot foil stamping the logo using a metallic foil at a temperature in a range of about 180° C. to about 220° C. and at a pressure in a range of about 3 kg/m² to about 5 kg/m².

4. The method as claimed in claim 1, wherein coating the second layer comprises:
depositing the second layer on the hot foil imprint through spray coating; and
heating the second layer at a temperature in a range of about 55° C. to about 60° C. for a time duration in a range about 10 minutes to about 15 minutes.

5. The method as claimed in claim 1, wherein coating the third layer comprises:
depositing the third layer on the second layer through spray coating; and
heating the third layer at a temperature in a range of about 50° C. to about 60° C. for a time duration in a range of about 10 minutes to about 15 minutes; and
exposing the third layer to ultra-violet radiations with radiant exposure in a range of about 700 milliJoule/cm² to about 1,200 milliJoule/cm² for a time duration in a range of about 15 seconds to about 60 seconds.

6. An enclosure of a device, comprising:
a thermally cured layer coated on a surface of the enclosure to level irregularities on the surface;
a hot foil logo formed on the thermally cured layer;
a thermally cured transparent layer coated on the hot foil logo; and
an ultra-violet (UV) cured transparent layer coated on the thermally G red transparent layer.

7. The enclosure as claimed in claim 6, wherein the thermally cured layer has a thickness in a range of about 8 μm to about 15 μm.

8. The enclosure as claimed in claim 6, wherein the thermally cured transparent layer has a thickness in range of about 1 μm to about 5 μm.

9. The enclosure as claimed in claim 6, wherein the UV cured transparent layer as a thickness In a range of about 10 μm to about 25 μm.

10. The enclosure as claimed in claim 6, wherein the hot foil logo has a thickness in a range of about 3 μm to about 25 μm.

11. The enclosure as claimed in claim 6, wherein the thermally cured layer is made of one of polyurethane, acrylic-polyurethane, and silicone rubber.

12. The enclosure as claimed in claim 6, wherein the thermally cured transparent layer is made of one of polyurethane, silicone rubber, and fluoropolymer.

13. The enclosure as claimed in claim 6, wherein the UV cured transparent layer is made of one of polyurethane, polycarbonate, urethane acrylates, polyacrylate, polystyrene, polyetheretherketone, polyesters, fluoropolymers, and a combination thereof.

14. A device having an enclosure comprising:
a primer layer coated on a surface of the enclosure;
a thermally cured layer coated on the primer layer to level irregularities on the surface;
a hot foil logo embossed on the thermally cured layer through hot oil stamping of a metallic foil;
and
a thermally red transparent layer coated on the hot foil logo, the thermally cured transparent layer being coated with an ultra-violet (UV) cured transparent layer, wherein the thermally cured transparent layer is to bind the hot foil logo with the UV cured transparent layer.

15. The device as claimed in claim 14, wherein the primer layer is made of one of acrylic-epoxy hybrids, acrylics, polycarbonate polyurethane and acrylic-polyurethane.
